(19) United States
(12) Patent Application Publication
(10) Pub. No.: US 2008/0066794 A1
(43) Pub. Date: Mar. 20, 2008

(54) AUTOMATIC HUNTING BLIND

(76) Inventor: Zachary Durfee, Salt Lake City, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/847,145

(22) Filed: Aug. 29, 2007

Related U.S. Application Data
(60) Provisional application No. 60/845,900, filed on Sep. 20, 2006.

(51) Int. Cl. A01M 31/02; E04H 15/02

(52) U.S. Cl. 135/96

(57) ABSTRACT

An automatic hunting blind is biased open and held shut with a latch. The latch may be remotely released with an electronic remote, control module, and solenoid to automatically open the blind. The automatic hunting blind allows a hunter to open the blind without losing visual contact with the prey and without moving their weapon into a position where the hunter is not ready to shoot the prey.

### RELATED APPLICATIONS

The present application claims the benefit of U.S. Provisional Application Ser. No. 60/845,900, filed Sep. 20, 2006, which is expressly incorporated herein in its entirety.

### BACKGROUND OF THE INVENTION

1. The Field of the Invention

The present invention relates to hunting blinds. More specifically, the present invention relates to an automatic hunting blind.

2. State of the Art

While hunting, it is often desirable to hide unnoticed while animals approach or move around in the area around the hunter. If the animal being hunted can not see the hunter, the animal will typically engage in normal feeding or resting activity rather than fleeing from the hunter. To this end, hunters have used hunting blinds.

Hunting blinds often have some type of frame or other structure which is covered with a camouflage material to thereby create an enclosure. When the hunter desires to shoot an animal, they often need to exit the enclosure or retract or otherwise move the blind to allow the hunter to shoot the animal. This is especially true in hunting birds, for example, where the hunter must typically track a flying bird through the air before shooting. Without removing or retracting the blind, the hunter typically does not have sufficient range of vision or motion to easily shoot the animal.

It is appreciated that the sudden movement of the hunting blind will often scare the animal and cause a resting animal to flee. Thus, the hunter must be prepared to shoot the animal relatively quickly and must be able to track the fleeing animal. Thus, hunting blinds which are cumbersome to remove may cause the hunter to lose the animal.

To this end, various hunting blinds have been created which allow a hunter to open the blind by sliding or pivoting a bar or piece of the frame, or to pull on a lever to open the blind. Such blinds open more quickly and easily, but still require the hunter to set down or take his or her hands off of their weapon to open the blind. The hunter is thus not ready to shoot the animal.

There is thus a need for a hunting blind which overcomes the limitations of available hunting blinds. Specifically, there is a need for an automatic hunting blind which may be opened without the hunter removing their hands from their weapon and grasping a part of the blind.

### SUMMARY OF THE INVENTION

It is an object of the present invention to provide an improved automatic hunting blind.

According to one aspect of the invention, a hunting blind is provided which may be opened automatically so as to allow the hunter to be prepared to shoot at an animal being hunted. According to an aspect of the invention, a hunting blind is provided which opens automatically when a hunter presses on a release button. The release button may be held separately, such as a remote control, or may be mounted to the hunter's weapon.

These and other aspects of the present invention are realized in an automatic hunting blind as shown and described in the following figures and related description.

### BRIEF DESCRIPTION OF THE DRAWINGS

Various embodiments of the present invention are shown and described in reference to the numbered drawings wherein:

FIG. 1 shows an end view of a hunting blind of the present invention attached to a hunting boat;

FIG. 2 shows an end view of the hunting blind of FIG. 1 in a folded position;

FIG. 3 shows a side view of the hunting blind of FIG. 1;

FIG. 4 shows another end view of a hunting blind according to the present invention;

FIG. 5 shows a perspective view of a hunting blind frame according to the present invention;

FIG. 6 shows a perspective view of a blind using the frame of FIG. 5; and

FIG. 7 through FIG. 10 show end views of the frame of FIG. 5.

It will be appreciated that the drawings are illustrative and not limiting of the scope of the invention which is defined by the appended claims. The various embodiments shown accomplish various aspects and objects of the invention. It is appreciated that not all aspects of the invention may be clearly shown in a single FIGURE. Thus, multiple figures may be used to illustrate the various aspects of a single embodiment of the invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

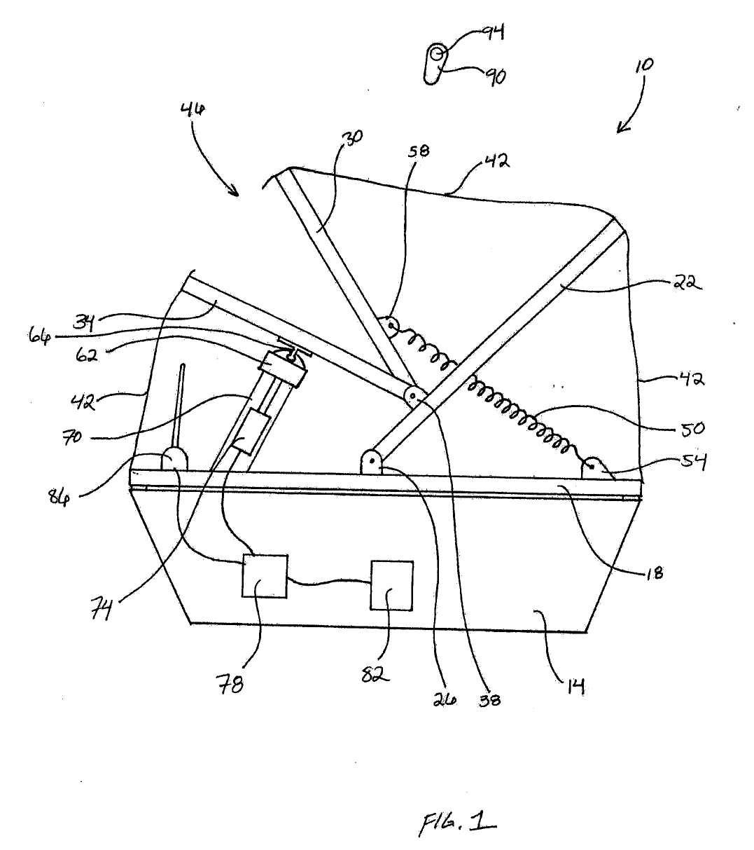

Turning now to FIG. 1, an end view of a hunting blind of the present invention mounted to a hunting boat is shown. The hunting blind, indicated generally at 10, is shown attached to a hunting boat 14. A cross member 18 may be used to mount the blind 10. The blind 10 has a plurality of U shaped frame members which form the frame of the blind. A primary pivoting frame member 22 is attached to the cross member 18 at pivot 26. Secondary pivoting frame members 30 and 34 are attached to the primary pivoting frame member at pivot 38. The pivoting frame members 22, 30, 34 are used to support a covering 42 and thereby provide a covered enclosure where a hunter can wait unnoticed by the prey. The covering 42 is typically a cloth with a camouflage pattern. The covering 42 typically includes an opening 46 through which a hunter may look and observe the prey prior to opening the blind 10.

The blind is biased into an open position; typically by a spring 50 (which could be a biasing element such as an elastic cord, etc.) which extends from a bracket 54 on the cross member 18 or boat 14 and another bracket 58 mounted to one of the pivoting frame members 22, 30, 34. The spring 50 is shown attached to pivoting frame member 30, but could be attached to a different pivoting frame member as well. The blind is held in a closed position, as shown, by a latch body 62 which receives a latch pin 66. As shown, the latch pin 66 is mounted to pivoting frame member 34 and the latch body 62 is mounted to the cross member 18 or to the boat. Releasing the latch allows the spring 50 to quickly pull the hunting blind 10 open.

The latch body 62 may be attached to the cross member 18 by a rigid bracket 70 or by a flexible tether. A rigid bracket 70 holds the latch body 62 in position when closing the blind 10 and may make operation easier as compared to a flexible tether, but remains in position when the blind is open, possibly creating a small obstacle.

The latch 62 is connected to a solenoid 74 which, when actuated, releases the latch 62 and allows the blind 10 to open. The solenoid 74 is electrically connected to a control module 78, which is connected to a power supply 82 and possibly to an antenna 86, if such is necessary. An antenna 86 may not be necessary if the control module 78 has an internal antenna or otherwise does not require an antenna. The control module communicates with a remote module 90. The remote module 90 has a button 94 which, when pressed, causes the remote module 90 to send a signal to the control module 78, actuating the solenoid 74, releasing the latch 62, and allowing the spring 50 to open the blind 10. The power supply 82 may be a battery, or may be the boat motor if so equipped.

In use, the present hunting blind provides several advantages over existing blinds. The hunting blind is spring loaded and opens automatically. The blind may thus open quickly and reliably. It is appreciated that, where a hunter must pull the blind open, the hunter may fail to open the blind quickly or completely and may compromise the shot. Additionally, the hunting blind 10 is opened with a remote 90. Thus, the hunter may hold the remote and need not reach for a release lever or the like, allowing the hunter to concentrate on the prey. The hunter may hold a small remote 90 while still holding their weapon. Additionally, the hunter may mount the remote module 90 on their weapon in a convenient location. The present invention allows the hunter to keep the weapon in a position where they are ready to fire at the prey.

The present system allows the hunter to maintain eye contact with the prey and to keep their weapon in a ready to fire position while opening the blind 10, providing greater chance of success. Existing blinds require that the hunter manually open the blind, often requiring the hunter to break visual contact with the prey and to move their weapon out of a ready to fire position.

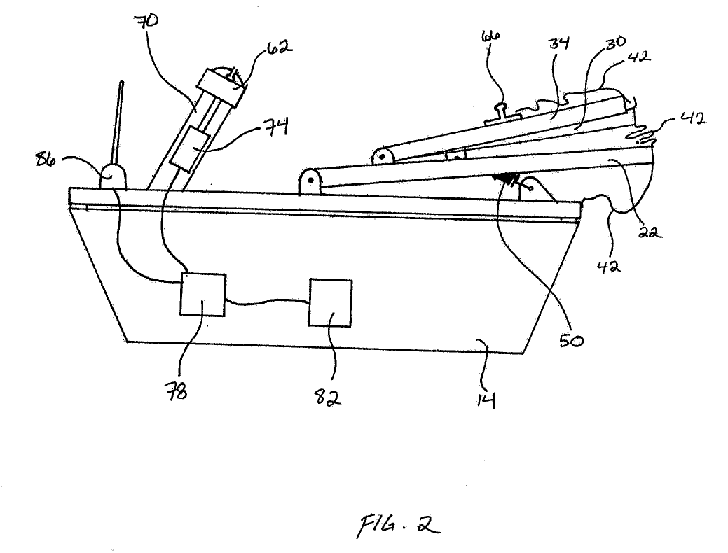

FIG. 2 shows an end view of the hunting blind of FIG. 1 in an open position. When the blind has been released, the latch pin 66 is released from the latch body 62 and the spring 50 pulls the blind, including the pivoting frame members 22, 30, 34 and covering 42 open and into a folded position as shown. Such movement will happen quickly and automatically. The automatic operation of the blind 10 allows the hunter to concentrate on the shot. When the blind 10 is open, the hunter has unobstructed visibility and a clear range of shooting.

To close the blind 10, a hunter would typically grasp the blind 10, such as at pivoting frame member 34, and pull the pivoting frame member and blind in a counterclockwise direction until the latch pin 66 engages the latch 62, locking the blind closed. The bracket 70 may be sufficiently rigid to hold the latch 62 so as to require little external support when closing the blind 10. As mentioned, the bracket 70 may be replaced by a flexible tether which would drop out of the way when the blind 10 is opened, but which would require that the hunter properly position and hold the latch 62 to close the blind.

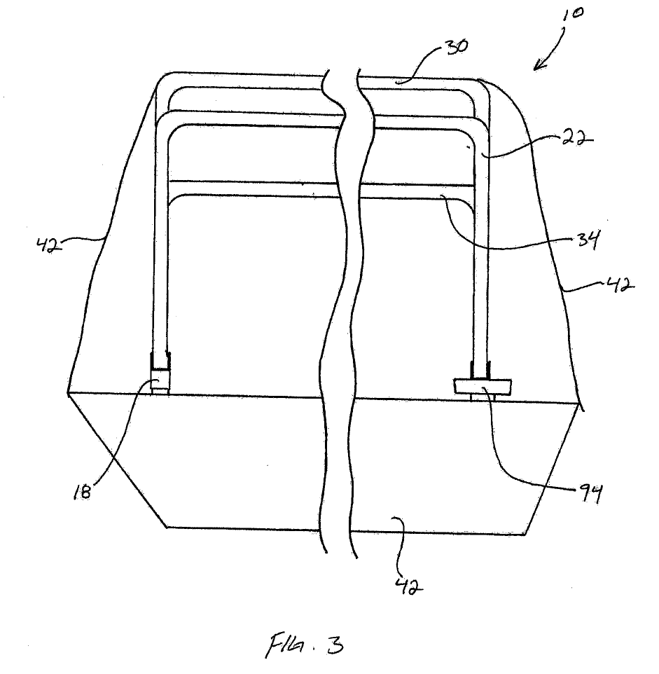

Turning now to FIG. 3, a side view of the hunting blind 10 of FIG. 1 is shown. The pivoting frame members 22, 30, 34 which form the framework of the blind 10 are often U shaped as shown. In making the blind 10, it is desirable to provide a framework which pivots open and closed with relative ease, and which, when covered by a covering 42, provides an enclosure of suitable size for one or more hunters. Thus, a hunting blind often extends between the front and back of a hunting boat. The blind may be mounted to the boat 14 by a cross member 18 as shown, or by a pedestal 94 or other mounting structure. Various different shapes of hunting blinds may be fitted with the spring 50, latch 62, latch pin 66, solenoid 74, control module 78, and remote module 90 of the present invention to provide an automatic hunting blind 10.

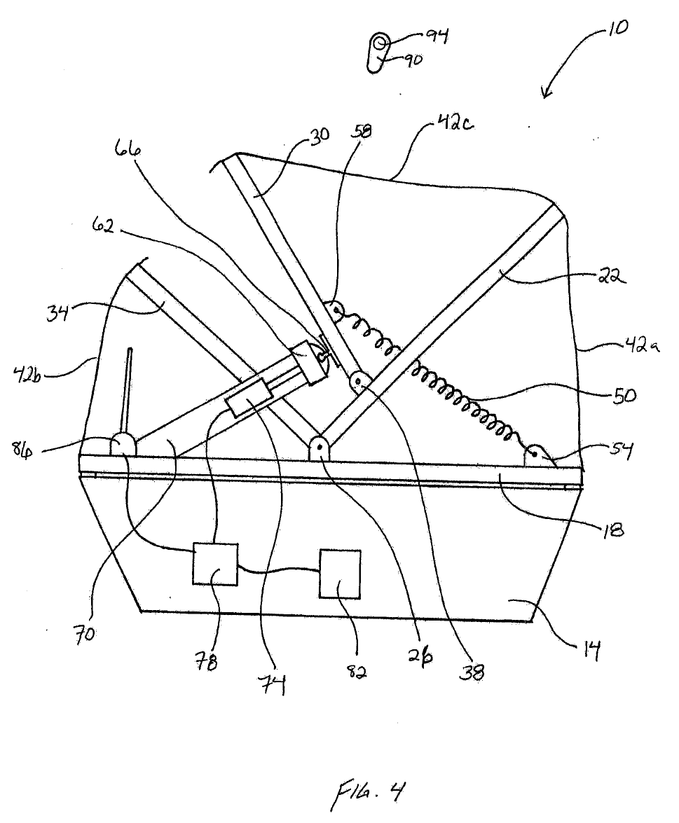

Turning now to FIG. 4, an end view of another blind according to the present invention is shown. The blind 10 is similar to that of FIG. 1, and is numbered accordingly. As such, the differences between the blind of FIG. 4 and that of FIG. 1 are primarily discussed, and not all structures are numbered or discussed. Unless discussed as different than corresponding structures of FIG. 1, the structures of FIG. 4 are understood to function similar to that of FIG. 1.

The blind 10 includes pivoting frame members 22, 30, and 34. Pivoting frame members 22 and 34 are held in a fixed location, and pivoting frame member 30 is opened to allow the hunter to shoot at the prey. Thus, when open, pivoting frame member 30 is moved adjacent pivoting frame member 22, allowing the side portions of the covering 42a, 42b to remain in approximately the position shown, with the upper portion of the covering 42c opens. It is thus appreciated that it may not be necessary to open the entire blind 10 to allow the hunter to shoot the prey. The spring 50 biases the pivoting frame member 30 into an open position, and the latch 62 and latch pin 66 are used to hold the pivoting frame member 30 in a closed position.

In discussing the automatic blinds of the present invention, it is appreciated that the blind structure often is formed from a supporting framework and a covering material. Other styles and shapes of hunting blinds may be used with the automatic opening features of the present invention. The frame, such as the pivoting frame members discussed herein, provides a rigid structure to define the shape of the blind and also provides the mechanical action to open and close the blind. The covering is often a relatively light and flexible covering, such as a canvas covering. A relatively light covering may be easier to use. It is appreciated that many different shapes and styles of blinds are possible with the present invention, and the specific shape of the blind is often determined by personal choice or by the structure to which the blind is attached. Thus, various sizes of boats will require various sizes of blinds.

The blinds of the present invention may be attached to various structures and locations desirable for hunting. For simplicity in discussing the present invention, the blinds are shown attached to a hunting boat. It is appreciated that there are various locations where a hunter may desire to mount a blind. For example, the blind may be attached to the ground or to a small enclosure mounted to the ground. Such a configuration would allow a hunter to hunt prey on ground, while a boat mounted blind allows a hunter to hunt on water. Accordingly, the blind may be formed in various sizes and shapes to accommodate the desired use. The blind will typically include a cross member, frame, or the like to facilitate attachment of the blind in the desired location, such as the boat, ground, etc. Thus, for use on the ground, an automatic blind may comprise pivoting frame members 22, 30, 34 with the covering 42 and the associated joints and pivots as necessary, the automatic opening devices of the present invention such as the spring 50, latch 62 latch pin 66, controls, etc., and a frame which is suitable for mounting to the ground or to an enclosure and which provides the necessary mechanical support for the framework of the blind itself.

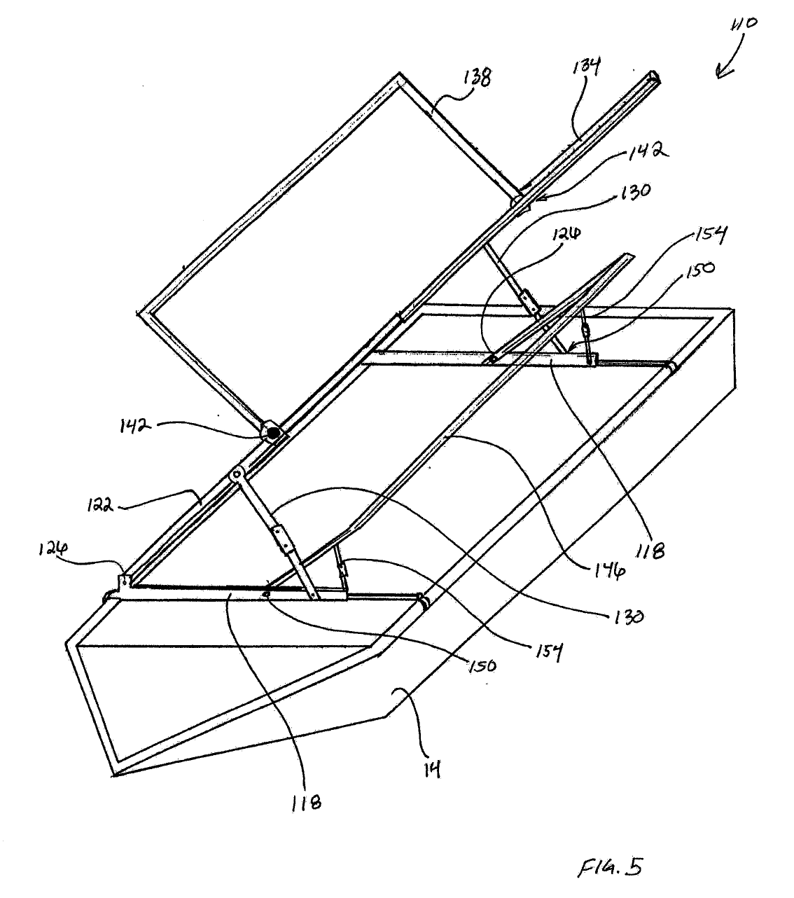

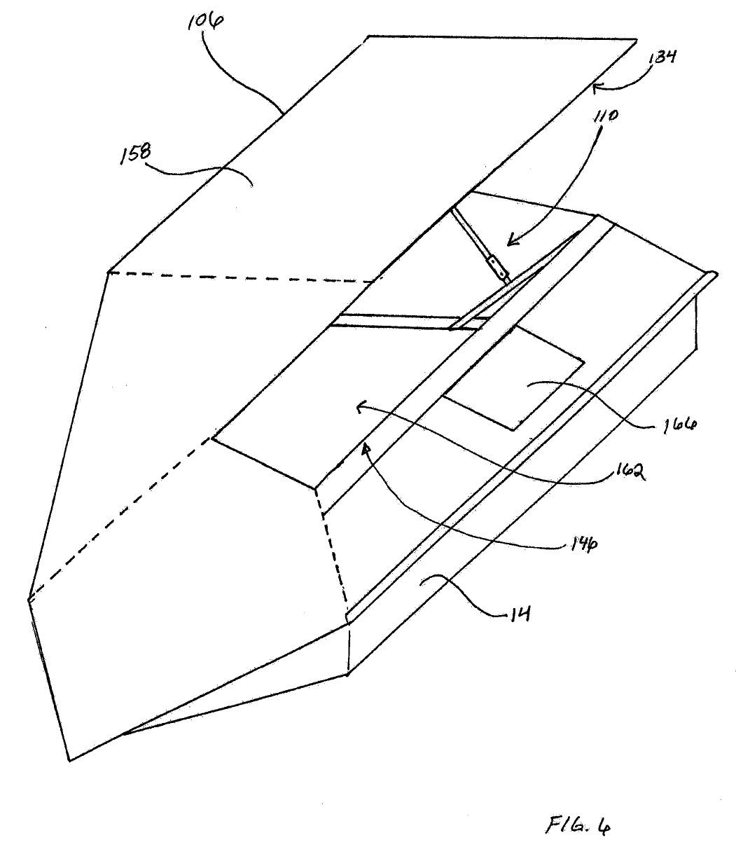

Turning now to FIG. 5, another perspective view of the frame 110 of an automatic hunting blind 106 of the present invention is shown. The hunting blind frame includes cross members 118 for supporting the frame and attaching the frame to a boat 14. A primary support member 122 is attached to the cross members 118 at pivots 126, and is held in position by braces 130. The primary support member 122 does not move during operation of the blind, but provides a support for a first pivoting frame member 134 and a second pivoting frame member 138. The first and second pivoting frame members 134, 138 are U shaped and extend along the length of the boat 14 to support the covering (FIG. 6). The first and second pivoting frame members 134, 138 are attached at pivots 142 such that they may pivot in a counter clockwise direction during operation of the blind.

A second support member 146 is attached to the cross members 118 at pivots 150. The second support member 146 is U shaped and extends along the length of the boat 14. The second support member does not move during operation of the blind, and is held in place by braces 154.

FIG. 6 shows a perspective view of the hunting blind 106 with the covering 158 in place. The covering 158 forms a generally closed canopy over the boat 14 which hides the hunters from the prey. The covering 158 is attached to the various parts of the frame 110 to secure the covering. An opening 162 is formed between the first pivoting frame member 134 and the second support member 146. The opening 162 allows the hunters to watch the prey. A dog door 166 may be formed in the covering 158 to allow a bird dog to enter and exit the boat 14. When the blind 106 is operated, the covering 158 is retracted to expose the hunters and provide them with an open view of the surroundings and an open shot at the prey. The covering 158 may be any known type of covering such as canvas, mesh, camouflage materials, etc.

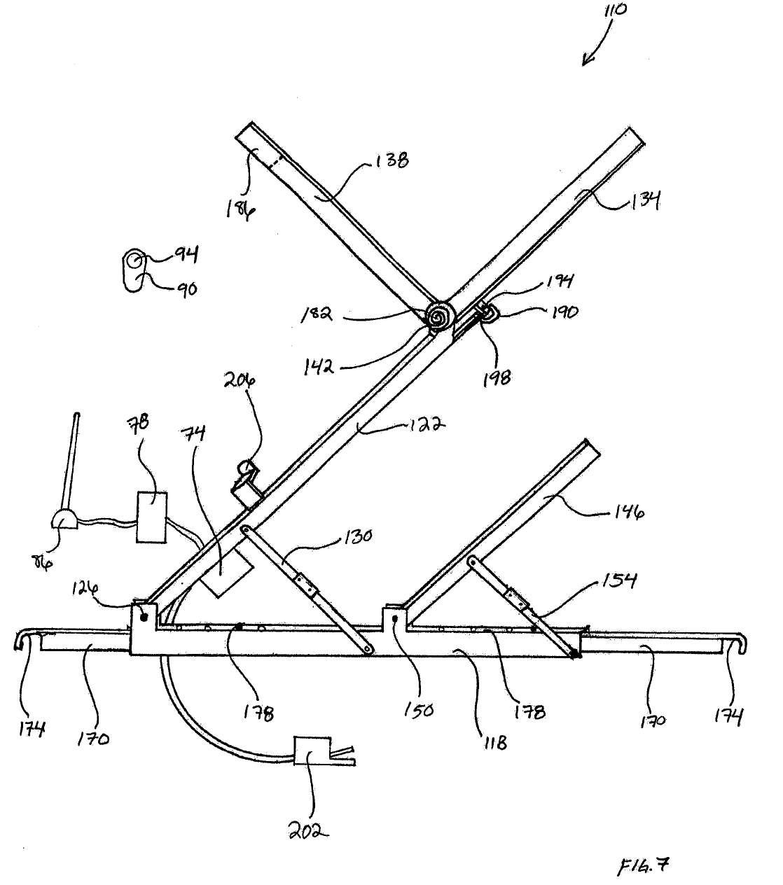

FIG. 7 shows a side view of the frame 110 to facilitate understanding of how the frame operates. For clarity, the covering 158 is not shown. The cross members 118 are adjustable in length, including extension arms 170 which slide therefrom. The extension arms 170 have hooks 174 or other means for attaching to the sides of the boat 14. Locks 178, such as holes with pins or push button locks, are used to fix the length of the cross member 118 to be fixed. This allows the hunting blind to be easily attached to many sizes of boats.

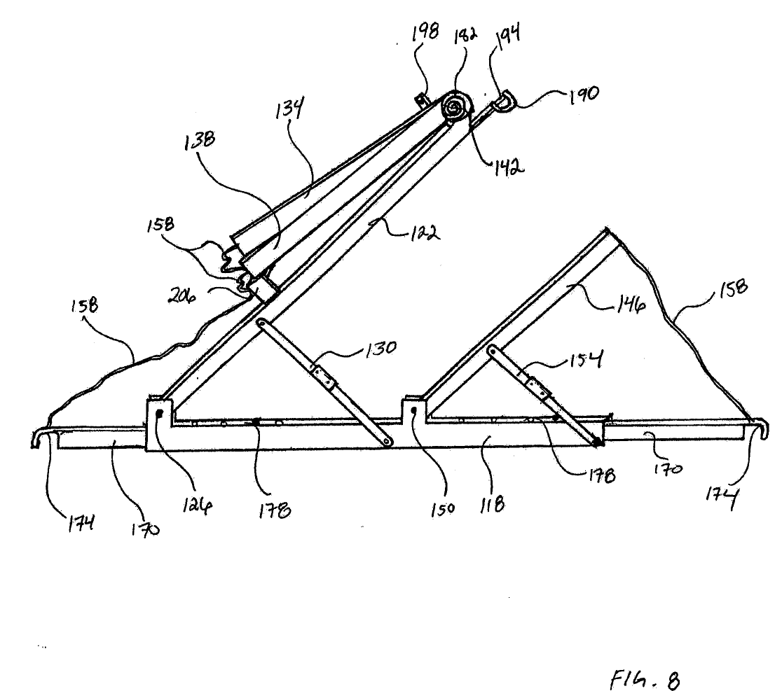

The second support member is pivoted upwardly from the cross members 118 and held in the position shown by the braces 154. When the blind 106 is in storage, the second support member 146 would be folded flat against the cross members 118, reducing the size of the blind. The primary support member 122 is also pivoted away from the cross members 118 into the position shown and held by the braces 130. For storage, the primary support member 122 is pivoted adjacent the cross members 118 and the first pivoting frame member 134 and second pivoting frame member 138 are pivoted in a counter clockwise direction adjacent the primary support member 122 (as shown in FIG. 8). The blind 106 thus folds up for storage or transportation and takes up very little space.

A biasing member such as a coil spring 182 is used to bias the first and second pivoting frame members 134, 138 in a counter clockwise direction so as to open the blind 106. A weight 186 may also be used such that gravity aids in opening the blind 106. The first and second pivoting frame members 134, 138 are held open by a latch 190. The latch 190 may include a latch pin 194 which engages a catch plate 198 attached to the first pivoting frame member 134. The latch 190 thus holds the first and second pivoting frame members 134, 138 in the position shown, the blind being in a closed position. When the latch 190 is released, the biasing member, such as the coil spring 182, weight 186, etc., will rotate the first and second pivoting frame members 134, 138 in a counter clockwise direction, and thus moving the covering 158 shown in FIG. 6, to open the blind. A stop 206 may be provided to limit the travel of the first and second pivoting frame members 134, 138 so as to avoid damage to the frame 110 or covering 158.

The latch 190 may be attached to a variety of release mechanisms. According to one aspect of the invention, a small wireless remote module 90 may be used to release the latch 190. The remote module is preferably small so as to be easily held, allowing a hunter to release the latch 190 while holding his gun in a position where he is ready to shoot. Pressing a button 94 on the remote module 90 will release the latch 190. Typically, using a remote module will require a solenoid 74, a control module 78, and an antenna 86. The solenoid 74 may pull on a release cable or rod which is connected to the latch 190. The remote module 90 and associated equipment will function as described previously.

In addition to or in the place of a remote module 90, a foot switch 202 may be provided. The foot switch 202 may also be connected to the release cable or rod and thereby be connected to the latch 190. A foot switch 202 may allow for operation of the blind 106 if power is lost. Additionally, providing a combination of foot switches 202 and a remote modules 90 may allow two or more persons to operate the blind 106. Where two or more persons are hunting together, having multiple remote modules 90, etc. would allow either person to operate the blind 106.

Turning now to FIG. 8, a side view of the frame 110 with the first and second pivoting frame members 134, 138 in a position where the blind 106 is open. For clarity, the foot switch 202, remote module 90, etc. are not shown. The covering 158 is shown, illustrating how pivoting the first and second pivoting frame members 134, 138 to the position shown removes the covering from above and to the sides of hunters who are using the blind, allowing them to shoot at a prey.

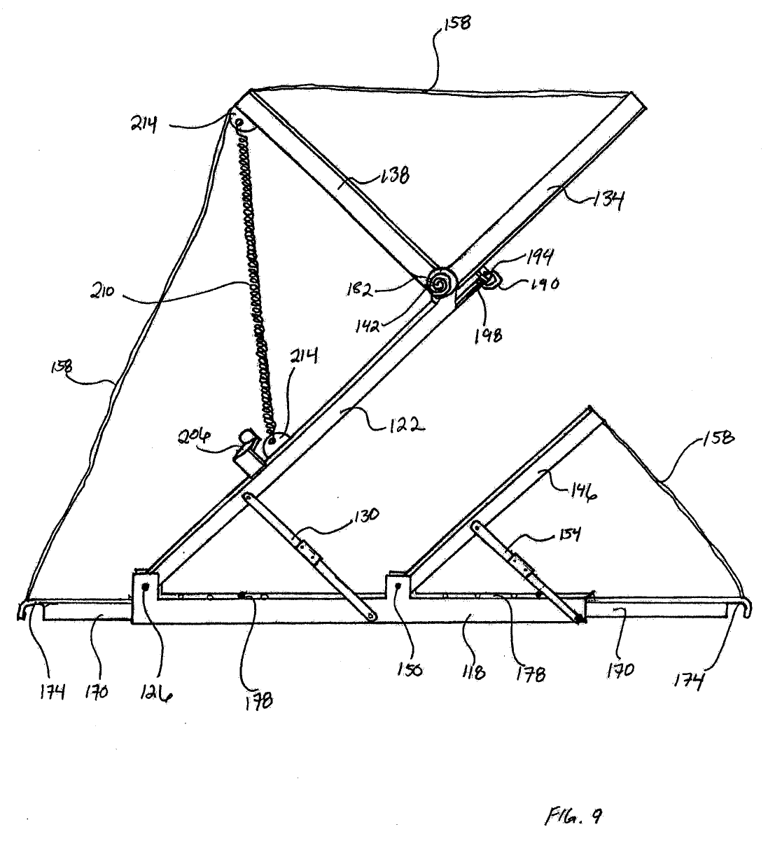

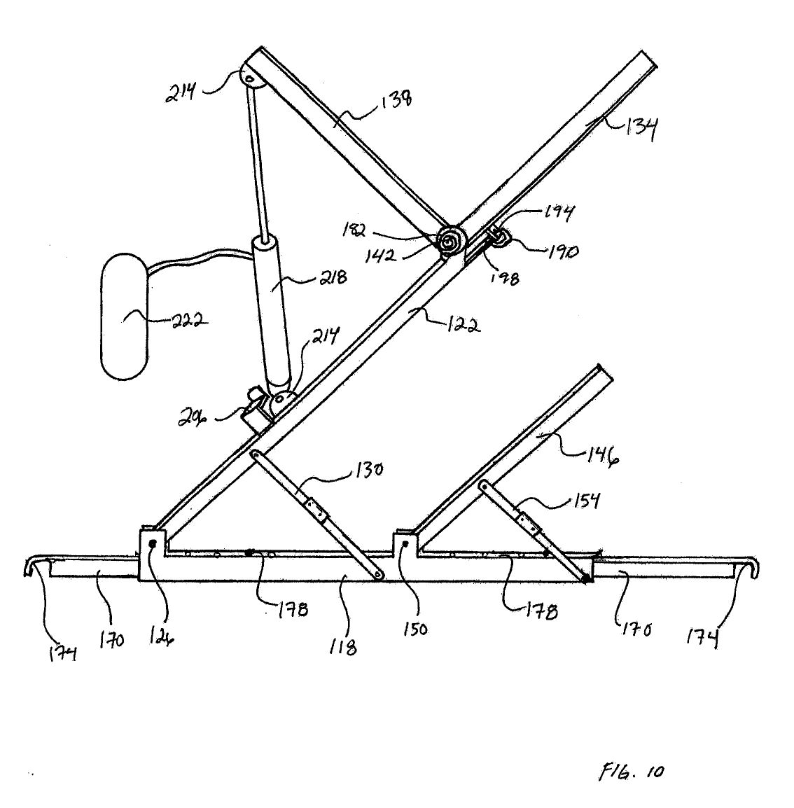

Turning now to FIGS. 9 and 10, side views of the frame 110 are shown, illustrating how additional or alternative biasing members may be used to aid in opening the blind. FIG. 9 illustrates how a tension spring 210 may be attached to the frame 110 via brackets 214 and used to aid in moving the first and second pivoting frame members 134, 138. FIG. 9 also shows the covering 158 in the closed position of the blind 106. FIG. 10 shows how a pneumatic or hydraulic piston 218 may be attached to the frame via brackets 214 and used to aid in opening the blind 106. The piston 218 may be attached to a pump, or may simply be attached to a supply of compressed air 222 such that the piston is always biased to open the blind.

It will be appreciated that it is desirable to open the blind quickly by rotating the first and second pivoting frame members 134, 138 in a counter clockwise direction. If the blind opens too slowly, the hunter may not be able to shoot at the prey before the animal leaves. It may thus be desirable to use a combination of tension springs 210, pistons 218, torsion springs 182, or weight 186 to ensure that the blind 106 opens properly.

There is thus disclosed an improved automatic hunting blind. It will be appreciated that numerous changes may be made to the present invention without departing from the scope of the claims.

What is claimed is:

1. An automatic hunting blind comprising:
a hunting blind;
a biasing element biasing the blind into an open position;
a latch for latching the blind into a closed position; and
means for allowing a hunter to release the latch and thereby open the blind via an electronic remote.

2. The blind of claim 1, wherein the blind comprises of a framework and a covering.

3. The blind of claim 1, wherein the biasing element comprises a spring.

4. The blind of claim 1, wherein the means for allowing a hunter to release the latch comprises a solenoid.

5. The blind of claim 4, wherein the solenoid is connected to a control module which communicates wirelessly with the electronic remote.

6. An automatic hunting blind comprising:
a frame, the frame comprising a movable frame member;
a covering material, the covering material being attached to the frame to form a generally enclosed area so as to conceal a hunter;
wherein the movable frame member is movable from a first position to a second position and wherein movement of the at least one movable frame member to the second position moves a portion of the covering material so as to expose the hunter and allow the hunter to shoot at a prey;
a biasing member for biasing the movable frame member into the second position;
a latch for selectively holding the movable frame member into the first position; and
a release mechanism configured for allowing the hunter to release the latch such that the movable frame member automatically moves to the second position.

7. The hunting blind of claim 6, wherein the release mechanism comprises a wireless remote module.

8. The hunting blind of claim 7, wherein the release mechanism further comprises a control module for receiving signals from the wireless remote module and for releasing the latch in response thereto.

9. The hunting blind of claim 8, further comprising a solenoid operatively connected to the latch.

10. The hunting blind of claim 6, wherein the frame is configured for attachment to a boat.

11. The hunting blind of claim 6, wherein the movable frame member is pivotably attached to the frame and wherein the movable frame member pivots from the first position to the second position to thereby open an area above the hunter.
